(19) United States
(12) Patent Application Publication
(10) Pub. No.: US 2014/0130599 A1
(43) Pub. Date: May 15, 2014

(54) METHOD FOR INSPECTING DEFECT POINT IN ADHESIVE LAYER OF FIBRE CLOTH

(71) Applicant: TAIWAN POWER TESTING TECHNOLOGY CO., LTD., (US)

(72) Inventor: YU-CHIANG LIN, New Taipei City (TW)

(73) Assignee: TAIWAN POWER TESTING TECHNOLOGY CO., LTD., New Taipei City (TW)

(21) Appl. No.: 13/739,551

(22) Filed: Jan. 11, 2013

(30) Foreign Application Priority Data
Nov. 14, 2012 (TW) 101142389

(51) Int. Cl. G01N 29/04

(52) U.S. Cl. CPC G01N 29/04
USPC 73/588

(57) ABSTRACT

The invention provides a method for inspecting defect point in adhesive layer of fibre cloth. The method includes following steps: spreading a fibre cloth; inspecting, by using two ultrasonic detectors, an upper surface and a lower surface of the fibre cloth simultaneously to sense a defect point in an adhesive layer of the fibre cloth; and analyzing an inspecting information sensed by the two ultrasonic detectors to obtain the situation of the defect point of the fibre cloth.

### CROSS-REFERENCE TO RELATED APPLICATION

This application claims priority to, and the benefit of, Taiwanese Patent Application entitled, “METHOD FOR INSPECTING DEFECT POINT IN ADHESIVE LAYER OF FIBRE CLOTH,” having application Ser. No. 101142389, filed on Nov. 14, 2012, which is incorporated by reference in its entirety.

### FIELD OF THE INVENTION

The present invention relates to a method for inspecting fibre cloth, and more particularly to a method for inspecting defect point in adhesive layer of fibre cloth.

### BACKGROUND OF THE INVENTION

Fibre cloth is widely used in modern life. The fibre cloth is applied to various objects, such as clothes, a cover of equipment shell, and architectural materials. And the quality of these objects is relative to the property of the fibre cloth, such as the strength and the stiffness of the fibre cloth. In view of this, the inspection of fibre cloth is therefor so essential in order to choose the fibre cloth with good quality.

The fibre cloth is generally gummed to be hard and glued to be formed as a multilayer fibre cloth to have the fibre cloth thicker and stronger. Defect points existing in the adhesive layer of the fibre cloth that is gummed or glued indicates that part of fibre cloth has problems, such as poor gumming on surface, poor glue between layers, use of poor materials for gumming or gluing, where these problems may reduce the mechanics property of the fibre cloth.

Traditional method for inspecting fibre cloth includes tensile strength testing, tensile rigidity testing, tensile elastic testing, and flexural strength testing, etc. Although some properties of the fibre cloth, such as the strength and the stiffness of the fibre cloth, can be detected by using those methods, however, the situation of the defect point in the adhesive layer of the fibre cloth still can't be detected.

### SUMMARY OF THE INVENTION

The defect point in the adhesive layer of the fibre cloth usually caused in the manufacturing processes. Moreover, traditional methods for inspecting fibre cloth are applied by only processing a part of fibre cloth which is not continuously used in the following manufacturing processes. It thus that the testing result generated by using the traditional methods which inspects fibre cloth that is not used in the following manufacture processes can not be taken as a trusted evaluation data of manufactured products.

Accordingly, an aspect of the present invention is to provide a method for inspecting defect point in adhesive layer of fibre cloth under which it solves the problems of untrustful evaluation data.

The method for inspecting defect point in adhesive layer of fibre cloth comprises following steps: (a) spreading a fibre cloth; (b) inspecting, by using two ultrasonic detectors, an upper surface and a lower surface of the fibre cloth simultaneously to sense a defect point in an adhesive layer of the fibre cloth; and (c) analyzing an inspecting information sensed by the two ultrasonic detectors to obtain the situation of the defect point of the fibre cloth.

According to an embodiment of the present invention, wherein the fibre cloth includes a carbon fibre cloth.

According to an embodiment of the present invention, wherein the step (b) includes a step of moving the position of the fibre cloth to make the fibre cloth move relative to the two ultrasonic detectors.

According to an embodiment of the present invention, wherein the step (b) includes a step of moving the position of the two ultrasonic detectors to make the two ultrasonic detectors move relative to the fibre cloth.

According to an embodiment of the present invention, wherein the fibre cloth is a multilayer glued fibre cloth.

According to an embodiment of the present invention, it further comprises, before step (a), a step of inspecting the thickness of each layer of the fibre cloth.

According to an embodiment of the present invention, wherein an acrylic component is provided on a side of the fibre cloth facing the ultrasonic detector.

According to an embodiment of the present invention, it further comprises, after step (b), a step of determining the fibre cloth as a defective product while the situation of the defect point of the fibre cloth exceeds a predetermined level.

According to an embodiment of the present invention, it further comprises, after step (b), a step of processing the inspecting information to obtain an inspecting map.

According to an embodiment of the present invention, it further comprises, after step (b), a step of marking a problem area on the inspecting map according to the situation of the defect point of the fibre cloth.

By means of technical means of the present invention, the situation of the defect point in adhesive layer of fibre cloth can be obtained in an ultrasound inspecting manner. And by a further detail inspection and a relational mapping, the depth, the shape, the size, the quantity, and the position of the defect point, can be known. Thereby, the manufactured product of the fibre cloth can be inspected in a nondestructive manner. And the accuracy of the fibre cloth inspection is increasing so that the manufacturing yield of the fibre cloth can be further raised.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating the method for inspecting defect point in adhesive layer of fibre cloth of the one embodiment according to the present invention;

FIG. 2 is a schematic diagram illustrating an inspecting system performing the method for inspecting defect point in adhesive layer of fibre cloth of the one embodiment according to the present invention;

FIG. 3 is a schematic diagram illustrating the fibre cloth of the one embodiment according to the present invention;

FIG. 4 is a schematic diagram illustrating one inspecting map of the one embodiment according to the present invention;

FIG. 5 is a schematic diagram illustrating another one inspecting map of the one embodiment according to the present invention;

FIG. 6 is a schematic diagram illustrating one inspecting system performing the method for inspecting defect point in adhesive layer of fibre cloth of the another one embodiment according to the present invention;

FIG. 7 is a schematic diagram illustrating another one inspecting system performing the method for inspecting defect point in adhesive layer of fibre cloth of the another one embodiment according to the present invention;

FIG. 8 is a schematic diagram illustrating another one inspecting system performing the method for inspecting defect point in adhesive layer of fibre cloth of the another one embodiment according to the present invention.

### DETAILED DESCRIPTION OF THE PREFERRED EMBODIMENTS

### The First Embodiment

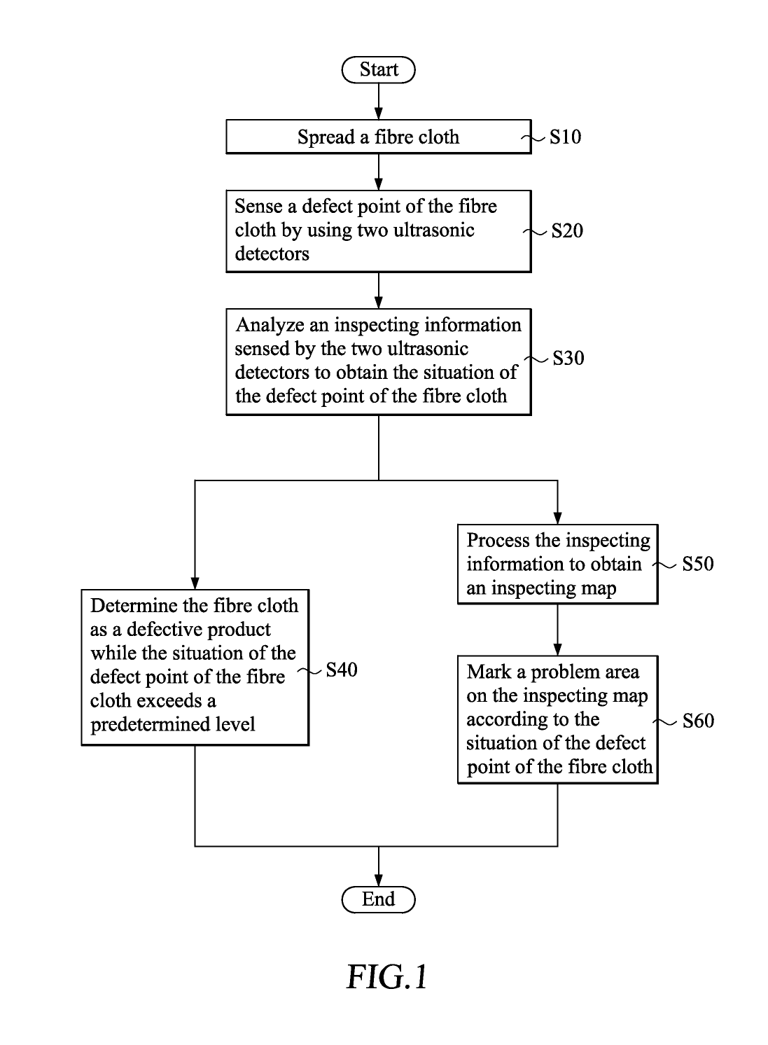

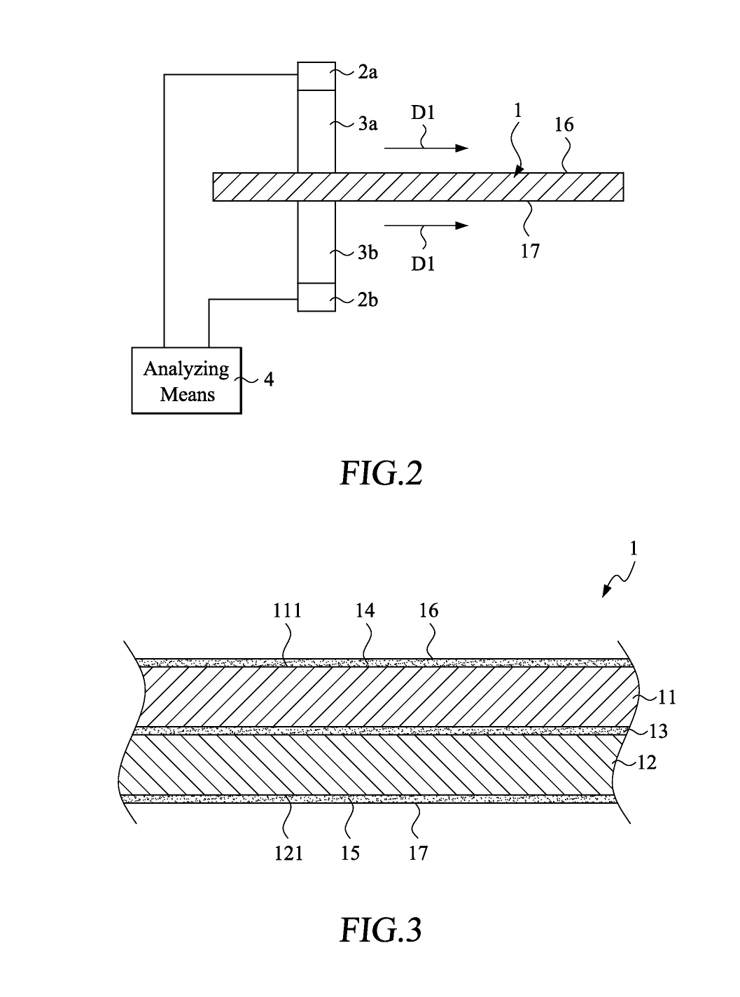

Refer to FIG. 1. FIG. 1 is a flowchart illustrating the method for inspecting defect point in adhesive layer of fibre cloth of the one embodiment according to the present invention. And also Refer to FIG. 2-FIG. 6 with FIG. 1.

The method for inspecting defect point in adhesive layer of fibre cloth is provided for inspecting a fibre cloth 1. The method for inspecting defect point in adhesive layer of fibre cloth can be applied to an inspecting system. The inspecting system includes two ultrasonic detectors 2a, 2b, two acrylic components 3a, 3b, and an analyzing means 4. The method for inspecting defect point in adhesive layer of fibre cloth comprises following steps: spreading a fibre cloth (Step S10); inspecting, by using two ultrasonic detectors, an upper surface and a lower surface of the fibre cloth simultaneously to sense a defect point in an adhesive layer of the fibre cloth (Step S20); and analyzing an inspecting information sensed by the two ultrasonic detectors to obtain the situation of the defect point of the fibre cloth (Step S30).

In order to clearly realize the condition of the defect point, in a preferred embodiment, after step S30, it further comprises steps of: determining the fibre cloth as a defective product while the situation of the defect point of the fibre cloth exceeds a predetermined level (Step S40); processing the inspecting information to obtain an inspecting map (Step S50); and marking a problem area on the inspecting map according to the situation of the defect point of the fibre cloth (Step S60).

As shown in FIG. 2, first, the fibre cloth 1 is spread (Step S10). In the embodiment, the fibre cloth 1 is a multilayer glued fibre cloth. The fibre cloth 1 includes two carbon fibre clothes 11, 12. An adhesive layer 13 is provided between the two carbon fibre clothes 11, 12 for bonding the two carbon fibre clothes 11, 12 with each other. In addition, in order to protect the surface of the fibre cloth 1 and to make the fibre cloth 1 harder and not easily deformed, an adhesive layer 14 and an adhesive layer 15 are provided on the upper surface 111 of the carbon fibre clothes 11 and the lower surface 121 of the carbon fibre clothes 12 respectively (as shown in FIG. 3).

Then, by using the two ultrasonic detectors 2a, 2b, an upper surface 16 and a lower surface 17 of the fibre cloth 1 are simultaneously inspected to sense a defect point in the adhesive layer 13,14,15 of the fibre cloth 1 (Step S20). Since the fibre cloth 1 itself is very thin, the propagating distances of the ultrasound delivering from the ultrasonic detectors 2a, 2b are hard to match with the thickness of the fibre cloth 1. It thus causes a poor inspecting accuracy. In order to increase the inspecting accuracy, the propagating distance of the ultrasound delivering from the ultrasonic detectors 2a, 2b to the fibre cloth 1 is required to be changed for matching the thickness of the fibre cloth 1. In the embodiment, in order to achieve the above object, the two acrylic component 3a, 3b are provided respectively on two sides of the fibre cloth 1 facing the ultrasonic detector, wherein the thickness of the acrylic component 3a, 3b is about 50 mm (millimeter) to 100 mm.

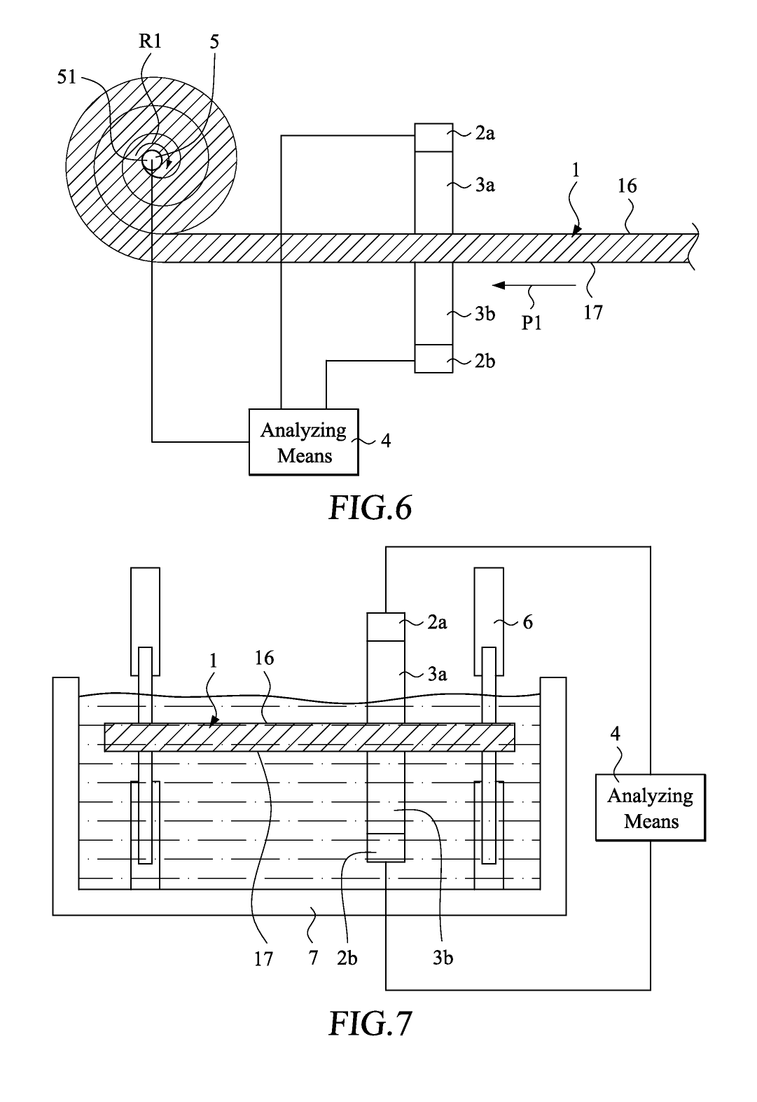

In the embodiment, the two ultrasonic detectors 2a, 2b move along a length direction D1 of the fibre cloth 1. The two ultrasonic detectors 2a, 2b move relative to the fibre cloth 1 so as to scan all length of the fibre cloth 1. Moreover, in the situation that the length of the fibre cloth 1 is much longer, in order to inspect all length of the fibre cloth 1, the position of the fibre cloth 1 is moved to make the fibre cloth 1 move relative to the two ultrasonic detectors 2a, 2b (as shown in FIG. 6). The fibre cloth 1 is shifted to move along a guiding path P1 to pass through the propagating area of the two ultrasonic detectors 2a, 2b. A pulling means 5 pulls the fibre cloth along the guiding path P1 (the direction of the guiding path P1 is contrary to that of the length direction D1 in FIG. 2) to make the fibre cloth 1 move to pass through the propagating area of the two ultrasonic detectors 2a, 2b. The pulling means 5 has a scroll 51 that rotates in a rotation direction R1 to pull the fibre cloth 1 and to scroll one end of the fibre cloth 1. By means of the pulling means 5, the two ultrasonic detectors 2a, 2b and the fibre cloth 1 move relative to each other, so that the position of the ultrasonic detectors 2a and that of ultrasonic detectors 2b can be fixed and the two ultrasonic detectors 2a, 2b do not have to move along the length direction of the fibre cloth as shown in FIG. 2.

And then, an inspecting information sensed by the two ultrasonic detectors 2a, 2b is analyzed to obtain the situation of the defect point of the fibre cloth 1 (Step S30). The two ultrasonic detectors 2a, 2b connect with an analyzing means 4 to transfer the inspecting information sensed by the two ultrasonic detectors 2a, 2b into the analyzing means 4. The analyzing means 4 analyzes the inspecting information to obtain the situation of the defect point of the fibre cloth 1, wherein the inspecting information includes the depth, the shape, and the size of the defect point of the fibre cloth 1.

In the FIG. 6, a transverse positional relation between the defect point and the fibre cloth 1 is determined according to the position of the fibre cloth 1 relative to the guiding path P1. And the position of the fibre cloth 1 relative to the guiding path P1 can be determined according to a pulling speed of the pulling means 5 (i.e. the value that the angular velocity of the scroll 51 multiplies the radius of the scroll 51 in this embodiment).

In the embodiment, it further comprises, before Step S10, a step of inspecting the thickness of each layer of the fibre cloth 1. After the depth of the defect point and that of each layer of the fibre cloth 1 in relation to its thickness is compared, it can distinguish that defect point exists in which layer of the multilayer glued fibre cloth.

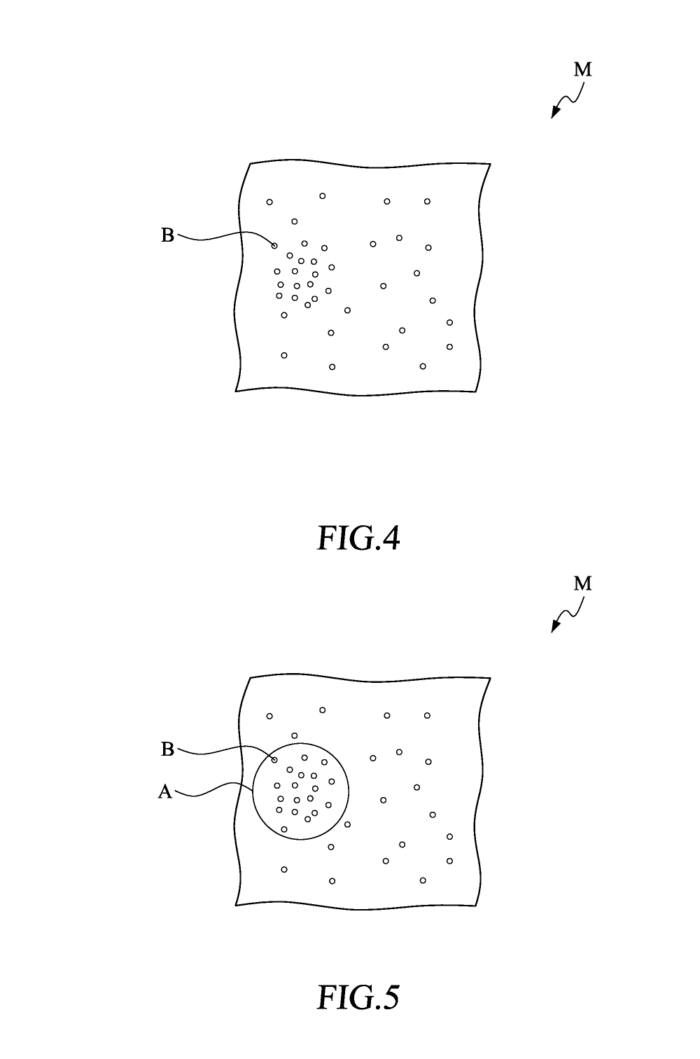

Furthermore, after Step S30, in the embodiment, a predetermined level is set in the analyzing means 4. The analyzing means 4 determines the fibre cloth 1 as a defective product while the situation of the defect point of the fibre cloth exceeds the predetermined level (Step S40). For example, the quantity of the defect points exceeds 10, or the total area of the defect points exceeds 1 cm². Moreover, the analyzing means 4 further can processes the inspecting information to obtain an inspecting map M that provides an obvious image for observing the defect point B, as show in FIG. 4 (Step S50). In addition, the analyzing means 4 marks a problem area A on the inspecting map M according to the situation of the defect point (Step S60), as shown in FIG. 5. By means of the assistance of the analyzing means 4, the severe problem area regarding the situation of the defect point can be observed more directly.

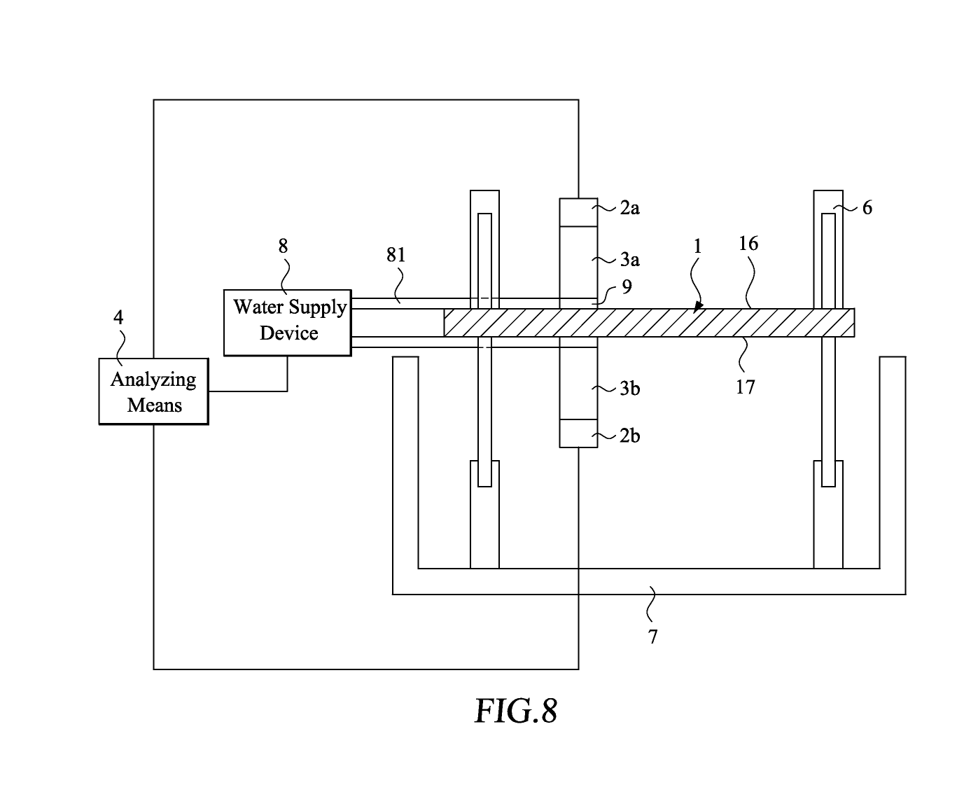

The ultrasound wave is a mechanical wave and particularly is a pressure wave generated by back and forth vibration of the particles of medium. The difference between the ultrasound wave and the electromagnetic wave is in that the ultrasound wave can not propagate through a vacuum space and must propagate through some mediums. The decay of the energy of the ultrasound wave in the water is much lesser than that in the air. In preferred embodiments, the fibre cloth 1 is moved, by an elevating device 6, into a water tank 7 filled with water, as shown in FIG. 7. Alternatively, a water supply device 8 is applied to supply water to a water bearing component 9, such as a hydrous fabric, between the arylic component 3a (or the arylic component 3b) and the fibre cloth 1 via a water transmission pipe 81, as shown in FIG. 8. Thereby the problem that the energy of the ultrasound wave decaies in the air can be overcome by using the water as the medium for propagating the ultrasound wave, and thus a complete clear inspecting image can be obtained

The above description should be considered as only the discussion of the preferred embodiments of the present invention. However, a person skilled in the art may make various modifications to the present invention. Those modifications still fall within the spirit and scope defined by the appended claims.

What is claimed is:

1. A method for inspecting defect point in adhesive layer of fibre cloth, comprising steps of:
(a) spreading a fibre cloth;
(b) inspecting, by using two ultrasonic detectors, an upper surface and a lower surface of the fibre cloth simultaneously to sense a defect point in an adhesive layer of the fibre cloth; and
(c) analyzing an inspecting information sensed by the two ultrasonic detectors to obtain the situation of the defect point of the fibre cloth.

2. The method for inspecting defect point in adhesive layer of fibre cloth as claimed in claim 1, wherein the fibre cloth includes a carbon fibre cloth.

3. The method for inspecting defect point in adhesive layer of fibre cloth as claimed in claim 1, wherein the step (b) includes a step of moving the position of the fibre cloth to make the fibre cloth move relative to the two ultrasonic detectors.

4. The method for inspecting defect point in adhesive layer of fibre cloth as claimed in claim 1, wherein the step (b) includes a step of moving the position of the two ultrasonic detectors to make the two ultrasonic detectors move relative to the fibre cloth.

5. The method for inspecting defect point in adhesive layer of fibre cloth as claimed in claim 1, wherein the fibre cloth is a multilayer glued fibre cloth.

6. The method for inspecting defect point in adhesive layer of fibre cloth as claimed in claim 5, further comprising, before step (a), a step of inspecting the thickness of each layer of the fibre cloth.

7. The method for inspecting defect point in adhesive layer of fibre cloth as claimed in claim 1, wherein an acrylic component is provided on a side of the fibre cloth facing the ultrasonic detector.

8. The method for inspecting defect point in adhesive layer of fibre cloth as claimed in claim 1, further comprising, after step (b), a step of determining the fibre cloth as a defective product while the situation of the defect point of the fibre cloth exceeds a predetermined level.

9. The method for inspecting defect point in adhesive layer of fibre cloth as claimed in claim 1, further comprising, after step (b), a step of processing the inspecting information to obtain an inspecting map.

10. The method for inspecting defect point in adhesive layer of fibre cloth as claimed in claim 9, further comprising, after step (b), a step of marking a problem area on the inspecting map according to the situation of the defect point of the fibre cloth.
